(19) United States
(12) Patent Application Publication
(10) Pub. No.: US 2020/0021780 A1
(43) Pub. Date: Jan. 16, 2020

(54) VISION UNIT

(71) Applicant: SUNGWOO HITECH CO., LTD., Busan (KR)

(72) Inventors: Kwang Wook Jeong, Busan (KR); Jaekyun Kim, Busan (KR); Byung Hag Park, Yongin-si (KR)

(21) Appl. No.: 16/282,433

(22) Filed: Feb. 22, 2019

(30) Foreign Application Priority Data
Jul. 10, 2018 (KR) 10-2018-0079838

(51) Int. Cl. H04N 7/18; B23P 19/04; B23K 37/04; B25J 11/00; G01B 11/00; H04N 5/225; H04N 5/232

(52) U.S. Cl. CPC H04N 7/185; B23P 19/04; B23K 37/0426; H04N 5/23299; G01B 11/002; H04N 5/2253; H04N 5/23203; B25J 11/005

(57) ABSTRACT

Disclosed is a vision unit. The vision unit according to the exemplary embodiment of the present invention may recognize a workspace for assembling components as a virtual vision coordinate system using reference pins at one side as reference coordinates by using a camera which is operated on a frame in six axial directions by multiple linear rails and multiple motors, may create position coordinates of the components, a welder, and the like in the workspace, and may ensure accurate positions of the components and the welder in the workspace recognized by the camera by converting the accurate positions of the components and the welder into numerical values, that is, position coordinates of the vision coordinate system so that multiple hanger robots and one or more welding robots may accurately perform operations of holding the components, correcting the positions, coupling the components, and performing welding and product inspection.

### CROSS-REFERENCE TO RELATED APPLICATION

This application claims priority to and the benefit of Korean Patent Application No. 10-2018-0079838 filed in the Korean Intellectual Property Office on Jul. 10, 2018, the entire contents of which are incorporated herein by reference.

### BACKGROUND OF THE INVENTION

### (a) Field of the Invention

The present invention relates to a vision unit, and more specifically, to a vision unit capable of recognizing a workspace for assembling components as a virtual vision coordinate system using reference pins as reference coordinates by using a camera that operates in six axial directions, and creating position coordinates of components, a welder, and the like positioned in the workspace.

### (b) Description of the Related Art

In general, in industrial fields, processes of assembling components are performed by using welding apparatuses in a state in which the components are held by exclusive jigs.

That is, the processes of assembling components are performed by seating the respective components on the exclusive jig by an operator, detecting omission of the components, seated states of the components, and the like by using a sensor or the like, and then performing a welding process by introducing a welder along a predetermined route by a welding robot in a state in which the respective components are fixed by a clamper.

However, in the related art, during the process of assembling components, the operator fixes the components on the fixed exclusive jig, the welding robot introduces the welder along the predetermined route, and then the welding process is performed, and as a result, there is a problem in that it is impossible to actively cope with forming tolerance of the components.

In a case in which there occurs a welding defect between the components due to the forming tolerance of the components or the operator's mistake as described above, there is a problem in that supplementary welding is performed manually or the components are discarded as defect products.

Meanwhile, because the aforementioned exclusive jig is manufactured by a facility dedicated to the corresponding components, there are problems in that a new jig needs to be manufactured each time a new type of vehicle is developed, and for this reason, facility investment costs such as jig manufacturing costs are incurred and electrical construction is needed every time the new jig is manufactured.

Accordingly, recently, researches and developments are performed on a component assembling system in which components to be assembled to each other are held and matched in a workspace and then assembled by welding by using multiple hanger robots that each have a hanger mounted at an arm tip to hold the component and multiple welding robots that each have a welder mounted at an arm tip.

In contrast to the fixed exclusive jig, this component assembling system has advantages in that it is possible to actively cope with forming tolerance of the components and to reduce facility investment costs because it is not necessary to newly manufacture a jig each time a new type of vehicle is developed.

However, accurate positions of the respective components and the welders are required to be ensured in the workspace in order to accurately perform, in the workspace, processes of accurately positioning the respective components held by the hangers of the respective hanger robots, correcting erroneous positions, coupling the respective components, and inspecting products after the assembly. This accurate positioning may be solved by converting the workspace into numerical values such as space coordinates.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a vision unit capable of recognizing a workspace for assembling components as a virtual vision coordinate system using reference pins at one side as reference coordinates by using a camera which is operated on a frame in six axial directions by multiple linear rails and multiple motors, and creating position coordinates of components, a welder, and the like in the workspace.

The present invention has also been made in an effort to provide a vision unit which ensures accurate positions of components and a welder in a workspace recognized by a camera by converting the accurate positions of the components and the welder into numerical values, that is, position coordinates of a vision coordinate system so that multiple hanger robots and one or more welding robots may accurately perform operations of holding the components, correcting the positions, coupling the components, and performing welding and product inspection.

A vision unit according to an exemplary embodiment of the present invention is configured to scan a workspace and transmit image information.

The vision unit may include: a frame which is installed in the workspace; a reference pin which is disposed above the frame and used as a coordinate reference; a first linear rail which is installed on the frame through a driving means and a rotating means, movable in an up and down direction on the frame, and rotatable in a left and right direction; a second linear rail which is installed on the first linear rail so as to be movable in the left and right direction relative to the frame; and a camera which is installed on the second linear rail so as to be movable in a front and rear direction relative to the frame, is movable in six axial directions in conjunction with the movements of the first and second linear rails, scans the workspace, and transmits image information.

The frame may include: two column beams which are installed to stand at left and right sides of a floor surface in the workspace; and an upper beam which is installed to connect upper ends of the two column beams.

The reference pins may be installed at both sides of a lower surface of the upper beam, and an end of each of the reference pins may be sharply and precisely processed.

The driving means may include: a first motor which is fixedly installed at a center of a front surface of the upper beam; two connecting shafts which are installed at both sides of the front surface of the upper beam so as to be rotatable in the left and right direction, and connected to a driving shaft of the first motor through a gear box installed at the center of the front surface of the upper beam so as to transmit power; two guide rails which are installed in the up and down direction on surfaces of the two column beams which face each other; two screw shafts which are installed in the up and down direction on front surfaces of the two column beams, have upper end portions connected to end portions of the two connecting shafts through gear boxes installed on the front surfaces at the upper ends of the two column beams so as to transmit power, and receive rotational power of the first motor; and two raising/lowering sliders which are slidably installed on the guide rails on the two column beams and raised or lowered in the up and down direction along the guide rails by the rotational force of the screw shafts in a state in which the two raising/lowering sliders mesh with the screw shafts through screw housings.

The rotating means may include: a second motor which is installed on one of the raising/lowering sliders of the driving means and includes a speed reducer; a bearing block which is installed on the other of the raising/lowering sliders of the driving means; and a rotating plate which is disposed between the two raising/lowering sliders, has the first linear rail installed thereon, and has one end connected to a rotating shaft of the speed reducer so that the rotating plate is rotated by rotational power of the second motor, and the other end connected to the bearing block.

The second linear rail may be installed on the first linear rail through a first slider that slides in the left and right direction.

A central portion of the second linear rail may be installed on the first linear rail through a first slider.

Each of the first and second linear rails may be configured as a rectilinear rail operated by a motor and a screw.

Each of the first and second linear rails may be configured as a linear motor that uses thrust generated by magnetic flux generated by an electric current supplied to a coil and magnetic flux of a magnet.

The camera may be installed on the second linear rail through a second slider that slides in the front and rear direction.

The vision unit may further include a vision controller which is provided outside the workspace and stores kinematical setup information of the vision unit in order to control a position of the camera.

The vision controller may include one or more processors that utilize programs and data for controlling the position of the camera.

Position control of the camera includes multiple moving points for sequentially moving the camera depending on ideal theoretical values calculated based on the kinematical setup information of the vision unit, and one or more postures made at the respective moving points.

Another exemplary embodiment of the present invention provides a vision unit which transmits image information by scanning a workspace; the vision unit including: a frame which is installed in the workspace; a reference pin which is configured above the frame and used as a coordinate reference; a first linear rail which extends on the frame in a left and right direction and has a first slider that slides in the left and right direction; a driving means which is configured on the frame and operates the first linear rail in an up and down direction by an operation of a motor; a rotating means which installs the first linear rail through a rotating plate which is connected to the driving means and rotated by the operation of the motor, and rotates the first linear rail in the left and right direction; a second linear rail which is installed on the first linear rail through a first slider so as to be moved in the left and right direction relative to the frame and has the second slider that slides in a front and rear direction; a camera which is installed on the second linear rail through the second slider so as to be moved in the front and rear direction relative to the frame, is movable in six axial directions in conjunction with the movements of the first and second linear rails, scans the workspace, and transmits image information; and a vision controller which is provided outside the workspace and stores kinematical setup information of the vision unit in order to control a position of the camera.

The frame may include: two column beams which are installed to stand at left and right sides of a floor surface in the workspace; and an upper beam which is installed to connect upper ends of the two column beams.

The reference pins may be installed at both sides of a lower surface of the upper beam, and an end of each of the reference pins may be sharply and precisely processed.

The driving means may include: a first motor which is fixedly installed at a center of a front surface of the upper beam; two connecting shafts which are installed at both sides of the front surface of the upper beam so as to be rotatable in the left and right direction, and connected to a driving shaft of the first motor through a gear box installed at the center of the front surface of the upper beam so as to transmit power; two guide rails which are installed in the up and down direction on surfaces of the two column beams which face each other; two screw shafts which are installed in the up and down direction on front surfaces of the two column beams, have upper end portions connected to end portions of the two connecting shafts through gear boxes installed on the front surfaces at the upper ends of the two column beams so as to transmit power, and receive rotational power of the first motor; and two raising/lowering sliders which are slidably installed on the guide rails on the two column beams and raised or lowered in the up and down direction along the guide rails by the rotational force of the screw shafts in a state in which the two raising/lowering sliders mesh with the screw shafts through screw housings.

The rotating means may include: a second motor which is installed on one of the raising/lowering sliders of the driving means and includes a speed reducer; a bearing block which is installed on the other of the raising/lowering sliders of the driving means; and a rotating plate which is disposed between the two raising/lowering sliders, has the first linear rail installed thereon, and has one end connected to a rotating shaft of the speed reducer so that the rotating plate is rotated by rotational power of the second motor, and the other end connected to the bearing block.

Each of the first and second linear rails may be configured as a rectilinear rail operated by a motor and a screw.

Each of the first and second linear rails may be configured as a linear motor that uses thrust generated by magnetic flux generated by an electric current supplied to a coil and magnetic flux of a magnet.

The vision controller may include one or more processors that utilize programs and data for controlling the position of the camera, and position control of the camera may include multiple moving points for sequentially moving the camera depending on ideal theoretical values calculated based on the kinematical setup information of the vision unit, and one or more postures made at the respective moving points.

According to the exemplary embodiment of the present invention, the workspace for assembling components is recognized as the virtual vision coordinate system, which uses the reference pin at one side as a reference coordinate, by using the camera which is operated on the frame in the six axial directions by the two linear rails and the two motors, and the position coordinates of the components, the welder, and the like in the workspace are created and converted into numerical values, such that the process of assembling components in the workspace may be accurately performed.

Therefore, according to the vision unit according to the exemplary embodiment of the present invention, in the workspace recognized by the camera, the multiple hanger robots and the one or more welding robots ensure the accurate positions of the components and the welder by converting the accurate positions of the components and the welder into numerical values, thereby enabling operations of holding the components, correcting the positions, coupling the components, and performing welding and product inspection to be accurately performed.

In addition, other effects obtained or expected by the exemplary embodiments of the present invention will be directly or implicitly disclosed in the detailed description of the exemplary embodiments of the present invention. That is, various effects expected according to the exemplary embodiments of the present invention will be disclosed in the detailed description to be described below.

### BRIEF DESCRIPTION OF THE DRAWINGS

FIG. 1 is a configuration view of a component assembling system to which a vision unit according to an exemplary embodiment of the present invention is applied.

FIG. 2 is a control block diagram of the component assembling system to which the vision unit according to the exemplary embodiment of the present invention is applied.

FIG. 3 is a front perspective view of the vision unit according to the exemplary embodiment of the present invention.

FIG. 4 is a rear perspective view of the vision unit according to the exemplary embodiment of the present invention.

FIG. 5 is an exploded perspective view of a driving means applied to the vision unit according to the exemplary embodiment of the present invention.

FIG. 6 is an assembled perspective view of first and second linear rails and a camera applied to the vision unit according to the exemplary embodiment of the present invention.

FIG. 7 is a perspective view of the first linear rail applied to the vision unit according to the exemplary embodiment of the present invention.

FIG. 8 is a perspective view of the second linear rail applied to the vision unit according to the exemplary embodiment of the present invention.

FIG. 9 is a view illustrating a state in which the vision unit according to the exemplary embodiment of the present invention is used.

<Description of symbols>

| | |
|---|---|
| VU: Vision unit | |
| R1, R2, R3: First, second, and third hanger robots | |
| R4: Welding robot | VC: Vision controller |
| RC: Robot controller | 11: Camera |
| 13: Frame | 13a: Column beam |
| 13b: Upper beam | 15: Reference pin |
| 21: Monitor | 31: Alarm |
| 41: Connecting shaft | 42: Fixing plate |
| 43: Guide rail | 45: Screw shaft |
| 51, 53: Raising/lowering slider | 52: Screw housing |
| 55: Speed reducer | 57: Rotating plate |
| LR1, LR2: First and second linear rails | |
| SR1, SR2: First and second sliders | |
| M1, M2: First and second motors | |
| P1, P2, P3: First, second, and third components | |
| T: Correction tool | B: Bearing |
| H1, H2, H3: First, second, and third hangers | |
| W: Welder | GB: Gear box |

### DETAILED DESCRIPTION OF THE EMBODIMENTS

Hereinafter, a configuration and an operational principle of a vision unit according to an exemplary embodiment of the present invention will be described in detail with reference to the accompanying drawings and the detailed description.

However, the drawings illustrated below and the following detailed description relate to one of the various exemplary embodiments for effectively explaining features of the present invention, and the present invention is not limited only to the following drawings and the following description.

However, in the description of the present invention, the specific descriptions of publicly known related functions or configurations will be omitted when it is determined that the specific descriptions may unnecessarily obscure the subject matter of the present invention.

In addition, the terms used in the following description are defined considering the functions in the present disclosure and may vary depending on the intention or usual practice of a user or an operator, and the definition of the terms should be made based on the entire contents of the technology of the present invention.

In addition, in the exemplary embodiment of the present invention, the terms are appropriately modified, integrated, or separated and then used to efficiently describe key technical features and allow those skilled in the art to clearly understand the key technical features, but the present invention is never limited by the terms.

In addition, parts irrelevant to the description will be omitted to clearly describe the exemplary embodiments of the present invention, and the same or similar constituent elements will be designated by the same reference numerals throughout the specification. In the following description, names of constituent elements are classified as a first . . . , a second . . . , and the like so as to discriminate the constituent elements having the same name, and the names are not essentially limited to the order in the description below.

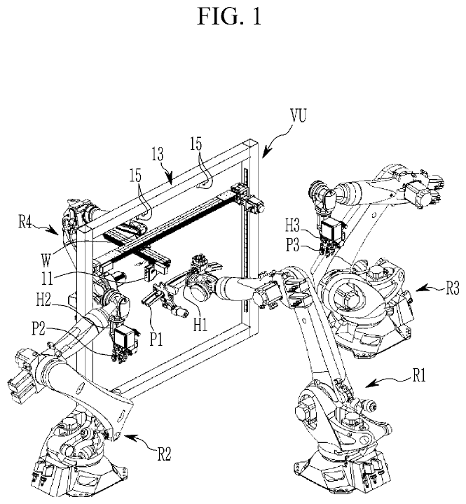

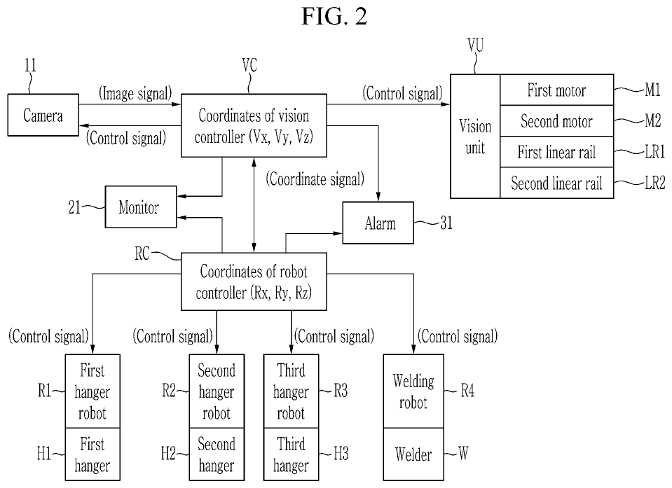

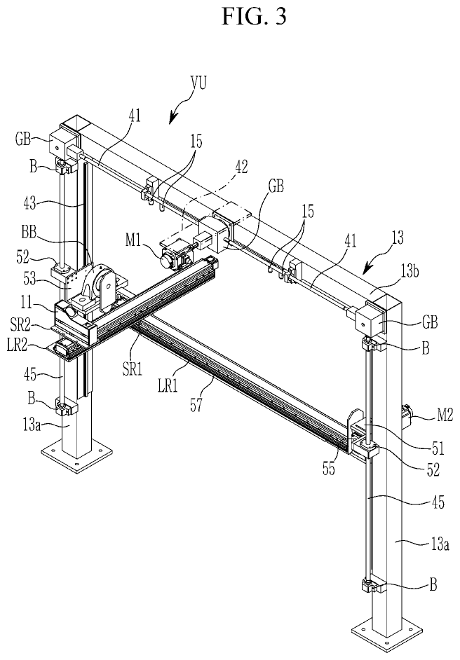

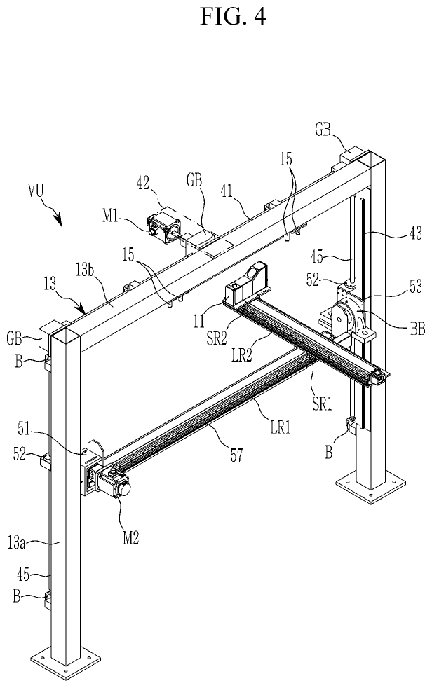

FIG. 1 is a configuration view of a component assembling system to which a vision unit according to an exemplary embodiment of the present invention is applied, FIG. 2 is a control block diagram of the component assembling system to which the vision unit according to the exemplary embodiment of the present invention is applied, FIG. 3 is a front perspective view of the vision unit according to the exemplary embodiment of the present invention, and FIG. 4 is a rear perspective view of the vision unit according to the exemplary embodiment of the present invention.

Referring to FIGS. 1 and 2, a vision unit VU according to an exemplary embodiment of the present invention is installed in a workspace of a component assembling system in which components are assembled.

The component assembling system, in which the vision unit VU is installed, includes three hanger robots R1, R2, and R3 which includes first, second, and third hanger robots R1, R2, and R3, respectively, a single welding robot R4, a vision controller VC which controls the vision unit VU, and a robot controller RC which controls the three hanger robots R1, R2, and R3 and the single welding robot R4.

Referring to FIGS. 3 and 4, the vision unit VU includes a frame 13 which is installed at one side of a workspace, reference pins 15 which are configured at one side on the frame 13 and used as coordinate references, a first linear rail LR1 which is movable in an up and down direction relative to the frame 13, a second linear rail LR2 which is movable in a left and right direction on the first linear rail LR1, and a camera 11 which is movable in a front and rear direction on the second linear rail LR2. The camera 11 may be moved in the up and down direction, the left and right direction, and the front and rear direction by the movements of the first and second linear rails LR1 and LR2. Here, the left and right direction is referred to as an x-axis direction, the front and rear direction is referred to as a y-axis direction, and the up and down direction is referred to as a z-axis direction.

The frame 13 has two column beams 13a which are formed in the form of a quadrangular beam and fixedly installed at both sides of the workspace in the x-axis direction, and an upper beam 13b which is installed to connect upper ends of the two column beams 13a.

The frame 13 may further include a separate support beam which is provided on a floor surface and configured to fix the two column beams 13a.

The reference pins 15 are installed at both sides of a lower surface of the upper beam 13b, respectively, and an end of each of the reference pins 15 is sharply and precisely processed. In the present exemplary embodiment, an example in which the two reference pins 15 are installed at either side of the lower surface of the upper beam 13b is described, but the present invention is not limited thereto.

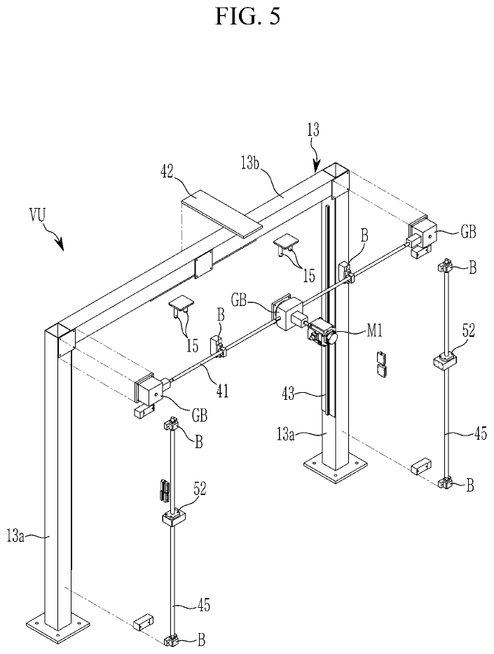

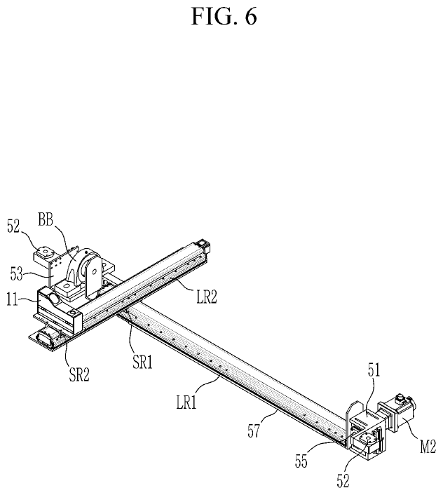

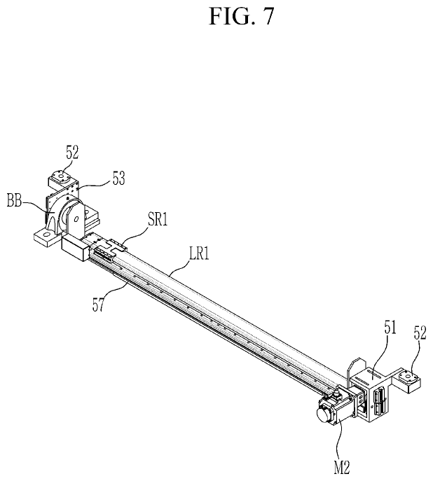

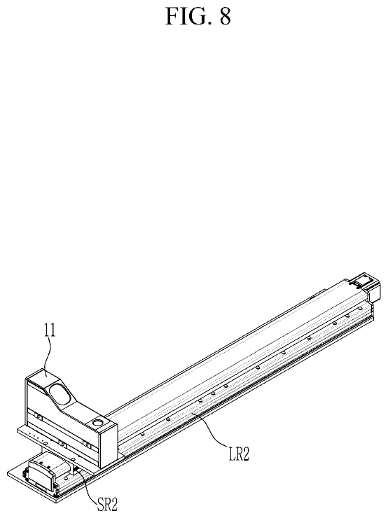

FIG. 5 is an exploded perspective view of a driving means applied to the vision unit according to the exemplary embodiment of the present invention, FIG. 6 is an assembled perspective view of first and second linear rails and a camera applied to the vision unit according to the exemplary embodiment of the present invention, FIG. 7 is a perspective view of the first linear rail applied to the vision unit according to the exemplary embodiment of the present invention, and FIG. 8 is a perspective view of the second linear rail applied to the vision unit according to the exemplary embodiment of the present invention.

Referring to FIGS. 5 to 7, the first linear rail LR1 is disposed between the two column beams 13a and configured to be rotatable about the x-axis while moving in the up and down direction (z-axis direction) along the two column beams 13a by a driving means and a rotating means.

The driving means includes a first motor M1, two connecting shafts 41, and a gear box GB. The first motor M1 is fixed at a center of a front surface of the upper beam 13b by a fixing plate 42, and the two connecting shafts 41 are installed at both sides of the front surface of the upper beam 13b so as to be rotatable about the x-axis, such that power may be transmitted from a driving shaft of the first motor M1 through the gear box GB installed at the center of the front surface of the upper beam 13b.

In this case, a central portion of each of the two connecting shafts 41 is supported on the upper beam 13b so as to be rotatable by a bearing B.

In addition, two guide rails 43 are formed in the up and down direction (z-axis direction) on surfaces of the two column beams 13a which face each other. Two screw shafts 45 are disposed in the up and down direction on front surfaces of the two column beams 13a and installed to be rotatable about the z-axis.

In this case, an upper end portion and a lower end portion of each of the two screw shafts 45 are supported on an upper end portion and a lower end portion of each of the two column beams 13a, respectively, so as to be rotatable about the z-axis by bearings B.

In addition, the upper end portion of each of the two screw shafts 45 is connected to the end portion of each of the two connecting shafts 41 so as to transmit power through a gear box GB installed on the front surface at the upper end of each of the two column beams 13a, such that each of the two screw shafts 45 receives rotational power of the first motor M1.

Here, the gear box GB refers to a box in which various types of gears are embedded to transmit rotational power of the first motor M1 by changing a rotation direction by 90 degrees. In this case, a straight, curved, helical, or Zerol bevel gear, a worm gear, a hypoid gear, or the like may be applied as various types of gears to be installed in the gear box GB, but the present invention is not necessarily limited thereto, and any gear set may be applied as long as the gear set may transmit rotational power of a motor by changing a rotation direction by a predetermined angle.

Two raising/lowering sliders 51 and 53, which are movable in the up and down direction along the guide rails 43 in a state in which the two raising/lowering sliders 51 and 53 mesh with the screw shafts 45, are configured on the guide rails 43 and the screw shafts 45 on the two column beams 13a.

That is, each of the two raising/lowering sliders 51 and 53 meshes with each of the two screw shafts 45 through a screw housing 52.

Here, a second motor M2, which includes a speed reducer 55, is installed on the raising/lowering slider 51, and a bearing block BB is installed on the raising/lowering slider 53.

In addition, both ends of a rotating plate 57 is installed on the speed reducer 55 and the bearing block BB between the two raising/lowering sliders 51 and 53. The rotating plate 57 receives rotational power of the second motor M2 which has a speed reduced by the speed reducer 55, and the rotating plate 57 rotates 360 degrees based on the two raising/lowering sliders 51 and 53.

Here, the first linear rail LR1 is installed on the rotating plate 57 and rotates together with the rotating plate 57, and a first slider SR1, which is slidable in the left and right direction (x-axis direction), is configured on the first linear rail LR1.

Referring to FIG. 8, a central portion of the second linear rail LR2 is installed on the first linear rail LR1 through the first slider SR1, and a second slider SR2, which is slidable in the front and rear direction (y-axis direction), is configured on the second linear rail LR2.

In this case, since the second linear rail LR2 is installed on the first linear rail LR1 through the first slider SR1, the second linear rail LR2 is rotated together with the rotating plate 57 by driving power of the second motor M2.

Here, a typical rectilinear rail, which is operated by a motor and a screw, may be applied as the first and second linear rails LR1 and LR2, but the present invention is not necessarily limited thereto, and a linear motor, which uses thrust generated by an interaction between magnetic flux generated by an electric current supplied to a coil and magnetic flux of a magnet, may be applied.

The camera 11 is installed on the second linear rail LR2 through the second slider SR2, and a 3D vision camera may be applied to obtain a 3D image for creating spatial coordinates of an object.

The camera 11 may be moved in the front and rear direction (y-axis direction) along the second linear rail LR2. Therefore, the camera 11 captures images of an object while being moved in the x-axis, y-axis, and z-axis directions by the movements of the first and second linear rails LR1 and LR2, and the camera 11 outputs image information.

That is, the vision unit VU recognizes ends of the reference pins 15 by using the camera 11 and recognizes a workspace as a virtual vision coordinate system by using the ends of the reference pins 15 as reference coordinates (origin coordinates). The vision unit VU recognizes objects such as the respective robots R1, R2, and R3 and components P1, P2, and P3 positioned in the workspace by using the camera 11 and outputs image information that uses the reference pins 15 as the reference coordinates.

Meanwhile, the component assembling system to which the vision unit VU according to the exemplary embodiment of the present invention is applied will be additionally described.

Referring to FIG. 1, the first, second, and third hanger robots R1, R2, and R3 are configured to have hangers H1, H2, and H3, respectively, each of which is installed at an arm tip of an articulated robot controlled by an operation of a six-axis servo motor and holds the component. The first, second, and third hanger robots R1, R2, and R3 are disposed at a front side of the vision unit VU in the workspace.

The number of hanger robots R1, R2, and R3 is three in the exemplary embodiment of the present invention, but two or four hanger robots may be provided, and the number of hanger robots may be determined, at a level at which an efficient management is enabled, in consideration of the number of components to be assembled in the workspace.

In addition, the welding robot R4 has a welder W installed at an arm tip of an articulated robot controlled by an operation of a six-axis servo motor, and the welding robot R4 is disposed at a rear side of the vision unit VU in the workspace.

In this case, a welding method is not limited, and an arc welder, a resistance welder, a friction stirring welder, a self-piercing riveting joining machine, a laser welder, or the like may be applied as the welder W, but an efficient welding method may be applied in consideration of welding properties of component materials, structural characteristics of welding portions, manageability in the workspace, and the like.

The number of welding robots R4 is one in the exemplary embodiment of the present invention, but two or three welding robots may be provided, and the number of welding robots may be determined, at a level at which an efficient management is enabled, in consideration of the workspace, the welding method to be applied, and the like.

In addition, the articulated robot is operated by being controlled by the six-axis servo motor in the exemplary embodiment of the present invention, but the present invention is not limited thereto, and the number of servo motors may be determined within a range in which there is no problem in selecting the positions of the components P1, P2, and P3 or the position of the welder W.

Here, the terms the hanger robots R1, R2, and R3 and the welding robot

R4 are different from one another to distinguish the terms in terms of the usage purpose, but the hanger robots R1, R2, and R3 and the welding robot R4 may be configured as the same robot, and the overall operations of the hanger robots R1, R2, and R3 and the welding robot R4 are controlled based on a control signal of the robot controller RC for controlling postures.

Referring to FIG. 2, the vision controller VC is provided outside the workspace, stores overall kinematical setup information of the vision unit VU in order to control a position of the camera 11, and controls an overall operation of controlling the position of the camera 11 so that the camera 11 recognizes the respective robots R1, R2, and R3 and the components P1, P2, and P3. Based on the image information of the robots R1, R2, and R3 and the components P1, P2, and P3 recognized by the camera 11, the vision controller VC creates accurate information about the positions in the workspace and sets correction values through coordinate correction.

The vision controller VC may include one or more processors that utilize programs and data for controlling the position of the camera 11. The position control of the camera 11 includes multiple moving points for sequentially moving the corresponding camera 11 depending on ideal theoretical values calculated based on the kinematical setup information of the vision unit VU, and one or more postures that may be made at the respective moving points.

In addition, the vision controller VC may set the workspace to a virtual vision coordinate system recognized by the camera 11 by using the reference pins 15 on the vision unit VU as coordinate references, may perform calibration for correcting the positions of the robots R1, R2, and R3 and the components P1, P2, and P3 based on coordinate values of the robots R1, R2, and R3 and the components P1, P2, and P3, which are positioned in the workspace, on the vision coordinate system, and may control one or more operations related to the position of the camera 11, the movement to a desired position, and posture control.

Here, the vision coordinate system (Vx, Vy, Vz) is a coordinate system in which the vision controller indicates the workspace as virtual spatial coordinates based on any one point in the workspace by using the camera 11 of the vision unit VU. The vision controller VC may indicate the positions of the robots R1, R2, and R3 or the components P1, P2, and P3 recognized by the camera 11 in the workspace for assembling the components, as spatial coordinates made based on vertices of the reference pins 15.

The vision controller VC is a main controller including multiple processors that utilize programs and data for creating and correcting overall coordinates of the robots R1, R2, and R3 and the components P1, P2, and P3 in the workspace for assembling the components, and the vision controller VC may be or may be controlled by a programmable logic controller (PLC), a PC, a workstation, or the like.

Referring to FIG. 2, the robot controller RC is provided outside the workspace, stores kinematical setup information for controlling the posture of the robot, and controls an overall operation of controlling the posture of the robot in order to assemble the components and perform welding.

The robot controller RC may include one or more processors that utilize programs and data for controlling the posture of the robot. The posture control of the robot includes multiple moving points for sequentially moving the corresponding robot depending on ideal theoretical values calculated based on kinematical setup information of the robot, and one or more postures that may be made at the respective moving points.

In addition, the robot controller RC may perform calibration for controlling the movements and the postures of the robots R1, R2, R3, and R4 in the workspace based on the robot coordinate system, and may control one or more operations related to the positions of the robots R1, R2, R3, and R4, the movement to a desired position, and the posture control.

Here, the robot coordinate system (Rx, Ry, Rz) is an inherent coordinate system of the robot for recognizing the movements of the hangers H1, H2, and H3 by the robot controller RC, and the robot coordinate system is defined as a coordinate system programmed in the robot controller RC. The robot coordinate system may indicate a position of a vertex of a correction tool (not illustrated) on a robot arm as a spatial coordinate.

In addition, the robot controller RC includes control logic for controlling the operations of the hangers H1, H2, and H3 on the three hanger robots R1, R2, and R3 and the operation of the welder W on the single welding robot R4.

Meanwhile, a model coordinate system (Mx, My, Mz) is used in the exemplary embodiment of the present invention. The model coordinate system (Mx, My, Mz) is a coordinate system that indicates a shape of a component model as a spatial coordinate on a drawing program for each of the components P1, P2, and P3. The model coordinate system may be managed by creating model data coordinates (i.e., referred to as car-line coordinates) that use position coordinates of the reference pins 15 as reference coordinates by inserting the reference pins 15, which are used as coordinate references on the vision coordinate system, into model data on the drawing program.

In addition, referring to FIG. 2, a component assembling robot system according to the exemplary embodiment of the present invention may further include a monitor 21 and an alarm 31.

The monitor 21 may display operation information and result information of the hanger robots R1, R2, and R3 and the welding robot R4 which are generated while the robot controller RC or the vision controller VC operates. That is, the monitor 21 may display image information captured by the camera 11 of the vision unit VU and information about movement routes of the hanger robots R1, R2, and R3 and the welding robot R4 as coordinate values, and may display information about the positions of the components P1, P2, and P3 in the workspace as coordinate values.

In addition, the monitor 21 may display defect information as letters or the like by being controlled by the robot controller RC and the vision controller VC.

The type of the monitor 21 is not limited as long as the monitor 21 may display the operation information and the result information. For example, the monitor 21 may be one of a liquid crystal display (LCD) device, an organic light emitting display (OLED) device, an electrophoretic display (EPD) device, and a light emitting diode (LED) display device.

In addition, the alarm 31 outputs defect information of the components P1, P2, and P3 by being controlled by the robot controller RC or the vision controller VC. Here, the defect information may be information for notifying an operator that defects occur on the components P1, P2, and P3 or products. For example, the defect information may be in the form of voice, graphics, light, or the like.

Therefore, the vision unit VU having the aforementioned configurations is applied to the component assembling system, and in the workspace, the vision unit VU is operated to recognize the workspace as the vision coordinate system in order to accurately assemble the multiple components P1, P2, and P3 by using the three hanger robots R1, R2, and R3, the hangers H1, H2, and H3, the single welding robot R4, and the welder W under the control of the vision controller VC and the robot controller RC.

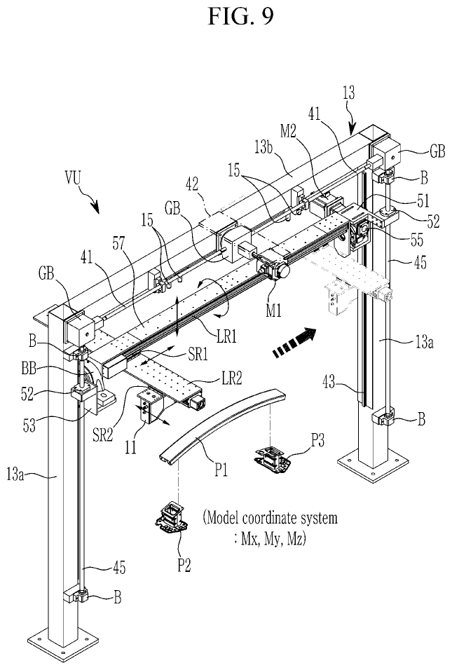

FIG. 9 is a view illustrating a state in which the vision unit according to the exemplary embodiment of the present invention is used.

Referring to FIG. 9, in the vision unit VU according to the exemplary embodiment of the present invention, the camera 11, which operates in the six axial directions relative to the frame 13 in conjunction with the operations of the first and second linear rails LR1 and LR2, scans the first, second, and third components P1, P2, and P3 positioned in the workspace by the three hanger robots R1, R2, and R3 based on the control signal of the vision controller VC.

Thereafter, the camera transmits the image information to the vision controller VC, and the vision controller VC analyzes the image information, creates position coordinates on the vision coordinate system which use the reference pins 15 as reference coordinates, and converts the accurate positions of the components P1, P2, and P3 in the workspace into numerical values.

As described above, the vision unit VU according to the exemplary embodiment of the present invention converts the accurate positions of the components P1, P2, and P3 positioned in the workspace in the component assembling system into numerical values, that is, position coordinates of the vision coordinate system, thereby allowing the components to be accurately held and enabling product inspection using the model data coordinates.

The vision unit VU is compatible even with components which have various specifications and are positioned in the workspace recognized as the vision coordinate system, and as a result, it is possible to reduce facility costs for assembly and it is not necessary to separately provide devices such as an inspection jig for inspecting a product for a defect.

In addition, the hanger robots R1, R2, and R3 may be controlled based on the components P1, P2, and P3 on the vision coordinate system recognized by the vision unit VU according to the exemplary embodiment of the present invention, such that it is possible to minimize a component holding error, forming tolerance of the components P1, P2, and P3, or a deformation error caused by welding of the components P1, P2, and P3.

In addition, the vision unit VU according to the exemplary embodiment of the present invention predicts and determines in advance interference among the components P1, P2, and P3, which are matched with one another, based on the position coordinate values recognized by the camera 11 at positions spaced apart from one another at a predetermined distance in the workspace, thereby allowing the components P1, P2, and P3 to be assembled in a state in which interference among the components P1, P2, and P3 is avoided by correcting positions of the components.

Therefore, it is possible to prevent deformation dispersion or quality dispersion of assembled products which is caused by assembling the components P1, P2, and P3 in an interference fit manner, and it is possible to reduce costs required to manufacture a jig because it is not necessary to manufacture an exclusive inspection jig.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vision unit which transmits image information by scanning a workspace; the vision unit comprising:
a frame which is installed in the workspace;
a reference pin which is disposed above the frame and used as a coordinate reference;
a first linear rail which is installed on the frame through a driving means and a rotating means, movable in an up and down direction on the frame, and rotatable in a left and right direction;
a second linear rail which is installed on the first linear rail so as to be movable in the left and right direction relative to the frame; and
a camera which is installed on the second linear rail so as to be movable in a front and rear direction relative to the frame, is movable in six axial directions in conjunction with the movements of the first and second linear rails, scans the workspace, and transmits image information.

2. The vision unit of claim 1, wherein:
the frame includes:
two column beams which are installed to stand at left and right sides of a floor surface in the workspace; and
an upper beam which is installed to connect upper ends of the two column beams.

3. The vision unit of claim 2, wherein:
the reference pins are installed at both sides of a lower surface of the upper beam, and an end of each of the reference pins is sharply and precisely processed.

4. The vision unit of claim 1, wherein:
the driving means includes:
a first motor which is fixedly installed at a center of a front surface of the upper beam;
two connecting shafts which are installed at both sides of the front surface of the upper beam so as to be rotatable in the left and right direction, and connected to a driving shaft of the first motor through a gear box installed at the center of the front surface of the upper beam so as to transmit power;
two guide rails which are installed in the up and down direction on surfaces of the two column beams which face each other;
two screw shafts which are installed in the up and down direction on front surfaces of the two column beams, have upper end portions connected to end portions of the two connecting shafts through gear boxes installed on the front surfaces at the upper ends of the two column beams so as to transmit power, and receive rotational power of the first motor; and
two raising/lowering sliders which are slidably installed on the guide rails on the two column beams and raised or lowered in the up and down direction along the guide rails by the rotational force of the screw shafts in a state in which the two raising/lowering sliders mesh with the screw shafts through screw housings.

5. The vision unit of claim 4, wherein:
the rotating means includes:
a second motor which is installed on one of the raising/lowering sliders of the driving means and includes a speed reducer;
a bearing block which is installed on the other of the raising/lowering sliders of the driving means; and
a rotating plate which is disposed between the two raising/lowering sliders, has the first linear rail installed thereon, and has one end connected to a rotating shaft of the speed reducer so that the rotating plate is rotated by rotational power of the second motor, and the other end connected to the bearing block.

6. The vision unit of claim 5, wherein:
the second linear rail is installed on the first linear rail through a first slider that slides in the left and right direction.

7. The vision unit of claim 1, wherein:
a central portion of the second linear rail is installed on the first linear rail through a first slider.

8. The vision unit of claim 1, wherein:
each of the first and second linear rails is configured as a rectilinear rail operated by a motor and a screw.

9. The vision unit of claim 1, wherein:
each of the first and second linear rails is configured as a linear motor that uses thrust generated by magnetic flux generated by an electric current supplied to a coil and magnetic flux of a magnet.

10. The vision unit of claim 1, wherein:
the camera is installed on the second linear rail through a second slider that slides in the front and rear direction.

11. The vision unit of claim 1, wherein:
the vision unit further includes a vision controller which is provided outside the workspace and stores kinematical setup information of the vision unit in order to control a position of the camera.

12. The vision unit of claim 11, wherein:
the vision controller includes one or more processors that utilize programs and data for controlling the position of the camera.

13. The vision unit of claim 12, wherein:
position control of the camera includes multiple moving points for sequentially moving the camera depending on ideal theoretical values calculated based on the kinematical setup information of the vision unit, and one or more postures made at the respective moving points.

14. A vision unit which transmits image information by scanning a workspace; the vision unit comprising:
a frame which is installed in the workspace;
a reference pin which is configured above the frame and used as a coordinate reference;
a first linear rail which extends on the frame in a left and right direction and has a first slider that slides in the left and right direction;
a driving means which is configured on the frame and operates the first linear rail in an up and down direction by an operation of a motor;
a rotating means which installs the first linear rail through a rotating plate which is connected to the driving means and rotated by the operation of the motor, and rotates the first linear rail in the left and right direction;
a second linear rail which is installed on the first linear rail through a first slider so as to be moved in the left and right direction relative to the frame and has the second slider that slides in a front and rear direction;
a camera which is installed on the second linear rail through the second slider so as to be moved in the front and rear direction relative to the frame, is movable in six axial directions in conjunction with the movements of the first and second linear rails, scans the workspace, and transmits image information; and
a vision controller which is provided outside the workspace and stores kinematical setup information of the vision unit in order to control a position of the camera.

15. The vision unit of claim 14, wherein:
the frame includes:
two column beams which are installed to stand at left and right sides of a floor surface in the workspace; and
an upper beam which is installed to connect upper ends of the two column beams.

16. The vision unit of claim 14, wherein:
the driving means includes:
a first motor which is fixedly installed at a center of a front surface of the upper beam;
two connecting shafts which are installed at both sides of the front surface of the upper beam so as to be rotatable in the left and right direction, and connected to a driving shaft of the first motor through a gear box installed at the center of the front surface of the upper beam so as to transmit power;
two guide rails which are installed in the up and down direction on surfaces of the two column beams which face each other;
two screw shafts which are installed in the up and down direction on front surfaces of the two column beams, have upper end portions connected to end portions of the two connecting shafts through gear boxes installed on the front surfaces at the upper ends of the two column beams so as to transmit power, and receive rotational power of the first motor; and
two raising/lowering sliders which are slidably installed on the guide rails on the two column beams and raised or lowered in the up and down direction along the guide rails by the rotational force of the screw shafts in a state in which the two raising/lowering sliders mesh with the screw shafts through screw housings.

17. The vision unit of claim 16, wherein:
the rotating means includes:
a second motor which is installed on one of the raising/lowering sliders of the driving means and includes a speed reducer;
a bearing block which is installed on the other of the raising/lowering sliders of the driving means; and
a rotating plate which is disposed between the two raising/lowering sliders, has the first linear rail installed thereon, and has one end connected to a rotating shaft of the speed reducer so that the rotating plate is rotated by rotational power of the second motor, and the other end connected to the bearing block.

18. The vision unit of claim 14, wherein:
each of the first and second linear rails is configured as a rectilinear rail operated by a motor and a screw.

19. The vision unit of claim 14, wherein:
each of the first and second linear rails is configured as a linear motor that uses thrust generated by magnetic flux generated by an electric current supplied to a coil and magnetic flux of a magnet.

20. The vision unit of claim 14, wherein:
the vision controller includes one or more processors that utilize programs and data for controlling the position of the camera, and
position control of the camera includes multiple moving points for sequentially moving the camera depending on ideal theoretical values calculated based on the kinematical setup information of the vision unit, and one or more postures made at the respective moving points.
